(19) United States
(12) Patent Application Publication
(10) Pub. No.: US 2018/0289577 A1
(43) Pub. Date: Oct. 11, 2018

(54) Six Degrees of Freedom Self Balanced Hybrid Serial-Parallel Robotic Systemfor Rehabilitation of Upper and Lower Limbs, Left and Right

(71) Applicant: Calabrian High TEch SRL, Rende (IT)

(72) Inventor: Guido Danieli, Cetraro (IT)

(21) Appl. No.: 15/545,032

(22) PCT Filed: Jan. 18, 2016
(86) PCT No.: PCT/IB2016/050217

§ 371 Date: Jul. 20, 2017

(30) Foreign Application Priority Data
Jan. 18, 2015 (IT) 102015902322112
Jan. 18, 2016 (IT) 102016000003654

(51) Int. Cl. A61H 1/02

(52) U.S. Cl. CPC A61H 1/02; A61H 1/0255; A61H 1/0277; A61H 1/0281; A61H 2201/1659; A61H 2230/825; A61H 2201/5061; A61H 2201/5064; A61H 2201/1635; A61H 2201/164; A61H 2201/5038

(57) ABSTRACT

Six degrees of freedom self balanced hybrid serial-parallel robotic system for rehabilitation of upper and lower limbs, left and right, characterized by the presence in each joint of motors and encoders controlled by microprocessors connected to a central governing unit, and of a first vertical axis hinge (1) followed by an horizontal axis parallelogram (2-2′″) bearing on the opposite side a counterweight (2″″), by a third and fourth vertical axes hinges (3 and 4), by a fifth horizontal axis hinge (5) and finally a sixth hinge placed perpendicularly to the previous (6), but far from this, as to be aligned with the prono-supination axis of the arm or intra-extra rotation of the leg, being also present an openable ring to hold the arm or leg aligned with such sixth hinge (8), the robotic system being able to move like an exoskeleton although it is not such, guiding correctly the movement of the limbs, thanks to the calculation capacity of its direct kinematics, after setting of the geometric parameters of the robot and calibration, and of reverse kinematic through process optimization, adapting its motion to the limb length of the individual patient which can be measured with the method described in the following claim, being also possible the presence of further counterweights to reduce strains on the structure and force sensors to measure forces and torques applied by the patient.

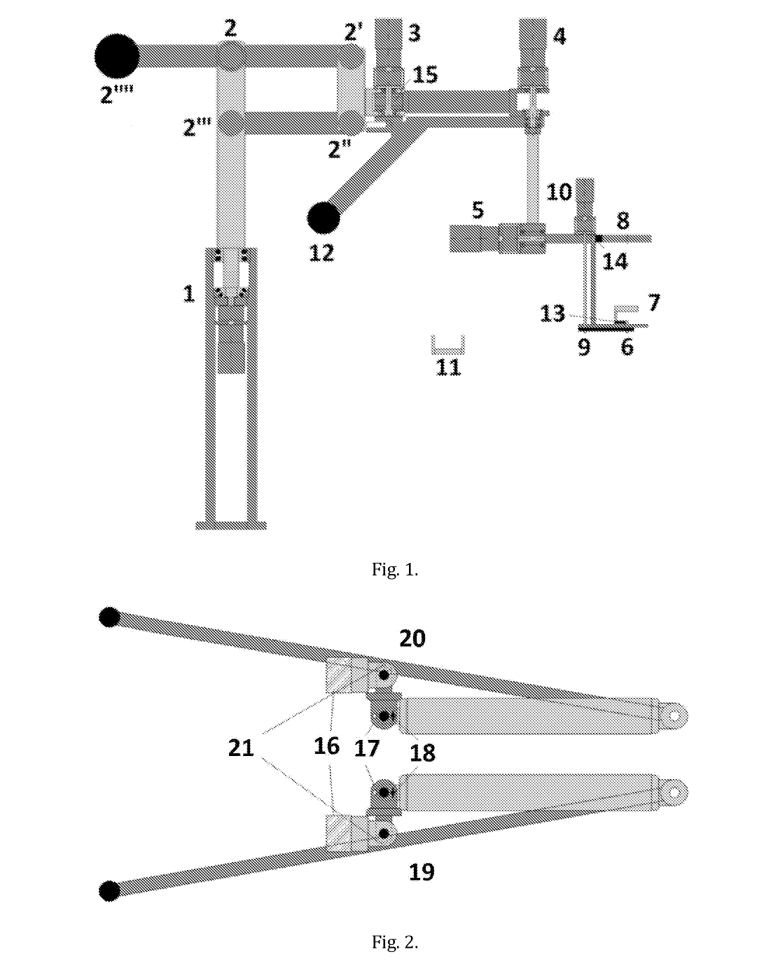

### STATE OF THE ART

In the field of rehabilitation several robots exist that can provide rehabilitation services of upper or lower limbs, often ambidextrous or double, so as to enable the rehabilitation of both sides, but none are able to provide all possible rehabilitation combinations, which is the aim of the tool presented here, stemming from a series of modifications to the Navi-Robot referred to patent EP1843876. For example, the Locomat is a robot double able to assist the rehabilitation of the lower limbs, while Aramis applies for the upper limbs, also in this case by acting on both limbs. In either case they are exoskeletal structures, while there are many other more specialized robots, such as the MIT Manus.

The idea instead is to provide a haptic system able to allow the largest variety of rehabilitative schemes, thanks to the use of a self-balanced six DOF structure managed by a central unit, and on which are applied force sensors capable of measuring forces and torques applied to the end effector, and in which all the joints are equipped with absolute encoders, geared motor assembly and microprocessor control, and able to be both moved passively without offering resistance, and actively in response to a force or torque applied, the extent of which can be adjusted by the rehabilitator. All with a simple programming, since it will be possible to teach the robot the exercise is meant to make the patient simply attacking the patient to the machine, then guiding him/she while performing the exercise, while the machine learns the exercise itself and then order the robot to repeat it endlessly. It will also be introduced a playful rehabilitation mode in which the patient has to move the robot, with the possibility of inclusion of games like Super Mario 3D, with or without haptic guidance to the path to follow.

Such a robot does not obviously have a structure of type exoskeletal, but as such behaves without the need for specific adjustments thanks to a software that will allow to move as such. Then we pass to the description of the structure of this robot, and subsequently to explain how is designed the software that allows it to move in a totally compatible way with the individual kinematics, as they should do exoskeletons, but at the price of a series of mechanical adjustments to be made for each patient.

### DESCRIPTION OF THE PREFERRED EMBODIMENT

Table 1 shows the basic structure of the robot. First of all we note how in the new Navi-Robot the constraint sequence is changed, while remaining a serial parallel hybrid structure, presenting the new structure of a first hinge (1) with vertical axis, while the second joint (2-2′″) consists in a parallel arms four bar link controlled by hinge (2), which allows the variation of the vertical position of the robot, and at the same time balancing the weight of the suspended structure thanks to the rear extension of the upper rocker arm (2″″). The third joint with a vertical axis (3) then permits the end of the member that branches off from this and which ends with the coupling (4) to reach any position in a cylindrical volume concentric with the hinge (1). We will return later to better describe the member that joins the hinges (3) and (4) because it is the structure that allows the use of this tool on both limbs right and left.

The joint (4) then it permits the complete rotation around a vertical axis of the last three members, to be connected to forearm or leg, allowing all possible movements. The hinge (5) allows in fact together with (4) the orientation in any direction of the end effector axis (joint 6), which coincides with the limb diaphysis being connected via the handle (7) and the centering element (8), free to slide. Moreover the joint (6), via in intermediate toothed belt (9), commanded by the motor (10), allows the movements of pronation and supination of the forearm and, by replacing the pedal (11) to the handlebar (7), of extra-intra-rotation of the leg. Obviously it is necessary to change the position of the chair which houses the patient, which must be set higher for the rehabilitation of hip and knee.

It is recalled that the whole structure is self-balanced in a passive way by the counterweight (2″″), while the counterweight (12) serves to cancel the torque effect on the quadrilateral produced by the rotation of the coupling (3). We return to this point speaking of Table 2. Note also that the motor (10) of the joint (6) is positioned so as to reduce the unbalance of the whole, which would be remarkable if the engine had been placed in correspondence of the coupling.

And again with (13) and (14) are indicated the positions of the triaxial force meters used to measure forces and torques both in passive mode (control of the resistance opposed by the patient which, if exceeding a preset value, cause the arrest and reversal of motion), that in the active mode, (in which two modes are provided, the first in which the robot moves the end effector in the direction given by a minimum thrust of the patient, the second in which it is required of the patient to exercise at least a predefined minimum force in order to move the robot). Of course, in this mode you can get an haptic 3D robot operation mode.

Finally with (15) indicates the double joint that allows the system to function both for right and left limbs, which is best illustrated in the following Table 2.

In this (16) indicates the connecting rod of the parallel arms four bar link in sectional view, while (17) indicates a male-female double coupling locking with the locking pin (18) so as to stop in two positions (19 and 20) that allow, the first, the rotation of 180° in a clockwise direction, to be used for the rehabilitation of the left limbs, while the second allows the rotation by 180° counter-clockwise for the rehabilitation of the right limbs. Note also that the two bars (21) holding the counterweight are on one side constrained to the joint (4) and the other part held in position by a pin placed on the double eccentric coupling (18), in order to counterbalance the torques caused by the rotation of member (3-4) about joint (3), causing the resultant of the forces to pass through the joint (3) axis.

In conclusion, we note that via software it is possible to use this structure as if it were an exoskeleton. We begin by noting that the robots we are talking about has a mechanical structure that makes it easy to calculate the direct kinematics and the inverse kinematics in the event the machine is built without errors (which is impossible) but that through the direct kinematics calibration (determining the end effector position knowing angle values of each joint) is simple to calculate by matrix multiplication. It would be more complicated to calculate the inverse kinematics in the presence of errors (calculation of angular parameters knowing the end effector position, final member of the Robot), if would not be performed a first calculation of the joint position in the ideal case, a simple trigonometric operation, from which, introducing an error function (distance between the required and that computed position introducing the angular parameters obtained initially in the function that calculates the correct direct kinematics) and making iterate the system while varying the joint parameters, up to find the minimum, which coincides precisely with the position requested. This seems complicated, but it is performed by a PC in a fraction of a second.

In parallel a kinematic model of the patient featuring two members (arm and forearm or thigh and leg) and 5 or 4 rotational parameters (a ball joint, the shoulder, and two planar hinges for elbow and wrist for the arm, or a spherical hinge, the hip, and a planar, the knee for leg), of which we have to determine the values during rehabilitation. In particular, once the robot is calibrated with the traditional method, it is possible to determine the length of the limbs of the patient and the position of the joints in the reference system of the robot. Basically, if we are talking about the upper limbs, we can simply touch the shoulder with the tip of the end effector, the coordinates of which are known by the reading of the encoders, and then setting the forearm on the same end effector, move it, to determine by analytical geometry, the position of the elbow, which is the point along the straight line that locates the axis of the forearm, which remains at a fixed distance with respect to the shoulder. Alternatively, initially blocking the arm for instance against the back of the chair, and only moving the forearm, the elbow is at the center of the sphere along which moves the handle of the hand. Given this, it is possible to determine the position of the shoulder, moving the arm and forearm, the shoulder is at the center of the sphere containing the positions of the elbow. Naturally, the same procedure can be used for hip and knee.

Once these are known, then it is sufficient to use the kinematic model of the patient's to calculate in which position you will find the lower arm (or leg) to make the required movement. At this point, by means of inverse kinematics of the robot, the sequence of values of the joint parameters through which the robot will have to pass (simultaneously) to obtain the required movement are computed. And yet, it is now easier for the rehabilitator, to teach the robot the exercise program that he/she wants the patient to play. It is sufficient that the rehabilitator sits in place of the patient, performs the required movements to supply the robot the dimensions of his/her limbs (movement of the forearm with the elbow in a fixed position, followed by the movement of the whole arm), then execute the exercise he intends the patient to carry out, then finally seat the patient on the chair, repeat the calibration procedure, and the system will adapt the motion previously recorded to the new joint dimensions.

It should be further noted how the system will be operated as the previous Navi-Robot from a distributed control system connected to a controlling unit via USB, and will be provided a series of basic programs that may be composed so as to allow ad hoc programming. And from this point of view, the system could also be called an “open source” rehabilitation robot. Regarding the motorization of the joints, it may be used either the motor unit described in patent EP1843876, or a motor unit consisting of a brushless or DC motor, reducer and encoder, with or without brake.

1. Six degrees of freedom self balanced hybrid serial-parallel robotic system for rehabilitation of upper and lower limbs, left and right, characterized by the presence in each joint of motors and encoders controlled by microprocessors connected to a central governing unit, and of a first vertical axis hinge (1) followed by an horizontal axis parallelogram (2-2″′) bearing on the opposite side a counterweight (2″″), by a third and fourth vertical axes hinges (3 and 4), by a fifth horizontal axis hinge (5) and finally a sixth hinge placed perpendicularly to the previous (6), but far from this, as to be aligned with the prono-supination axis of the arm or intra-extra rotation of the leg, being also present an openable ring to hold the arm or leg aligned with such sixth hinge (8), the robotic system being able to move like an exoskeleton although it is not such, guiding correctly the movement of the limbs, thanks to the calculation capacity of its direct kinematics, after setting of the geometric parameters of the robot and calibration, and of reverse kinematic through process optimization, adapting its motion to the limb length of the individual patient, which can be measured with the method described in the following claim, being also possible the presence of further counterweights to reduce strains on the structure and force sensors to measure forces and torques applied by the patient.

2. Six degrees of freedom self balanced hybrid serial-parallel robotic system for rehabilitation of upper and lower limbs, left and right as described in the first claim, in which the method to measure the length of each patient's limb, requires for example, after fixing the end effector to the forearm (whose axes coincide by design) to carry the elbow in contact of the back of the chair, moving then the forearm, which allows to easily determine, by measuring the motion, the coordinates of the point on which the system revolves, in the reference system of the robot, the elbow precisely, which is integral to the end effector, while then, with the patient well-fixed to the seat, by moving the arm and forearm in space, the shoulder position is determined as that of the center of the sphere along the surface of which has moved the elbow, thus obtaining the lengths of the arm and forearm, which allows, entering the kinematic model of the limb, to calculate the subsequent positions through which the forearm of the patient will pass during the exercise required, and therefore the sequence of joint parameters which the robot shall follow to properly guide the exercise.

3. Six degrees of freedom self balanced hybrid serial-parallel robotic system as per claim 1, in which the member connecting the third and fourth joints is composed by two elements, a very short double joint, and a second element just about long as the longer parallelogram bars, and a locking system to block at 90° the relative position of these two elements, but in one or the opposite direction, in order to allow 180° clockwise or counterclockwise rotation between maximum extension and maximum contraction.

4. Six degrees of freedom self balanced hybrid serial-parallel robotic system, as per claim 1, in which the second counterweight, if present, is placed at the end of a bar hinged on one side to the fourth joint, on the middle fixed to a pin placed eccentrically on the intermediate element between rod and arm connecting the third and fourth joints, in order to balance both the weight of whatever is suspended to the fourth joint, and the little torque produced by the arm's L shaped configuration.

5. Six degrees of freedom self balanced hybrid serial-parallel robotic system as per claim 1, in which each joint is governed by a microprocessor controlled via serial connection to a master board, itself controlled by a PC via USB, each joint bearing a motor, a possible speed reducer and an encoder.
